(19) United States
(12) Patent Application Publication
(10) Pub. No.: US 2015/0215671 A1
(43) Pub. Date: Jul. 30, 2015

(54) VIDEO SHARING MECHANISM WHERE IN THE FILTERS CAN BE CHANGED AFTER THE VIDEO IS SHARED WITH A FILTER

(71) Applicant: Google Inc., Mountain View, CA (US)

(72) Inventors: Justin Lewis, Marina del Rey, CA (US); Gavin James, Los Angeles, CA (US)

(73) Assignee: Google Inc., Mountain View, CA (US)

(21) Appl. No.: 14/165,385

(22) Filed: Jan. 27, 2014

(51) Int. Cl. H04N 21/4545; H04N 21/472; H04N 21/2743; H04N 21/237; H04L 29/06; H04L 12/58

(52) U.S. Cl. CPC H04N 21/45455; H04L 65/403; H04L 51/32; H04N 21/2743; H04N 21/237; H04N 21/47205

(57) ABSTRACT

In a method and system for sharing filtered content, first content is identified, and a filter is determined, wherein, when the filter is applied to the first content, filtered content is produced, and the filter is applied to the first content. A request is received to upload the filtered content, and the first content and filter data are sent to a server. A resource identifier indicating the first content and the filter data is received.

### TECHNICAL FIELD

Aspects of the present disclosure relate to the field of content sharing and, more particularly, to a method for sharing filtered content.

### BACKGROUND

On the Internet, content hosting websites or other applications allow users to upload, view, and share digital content. Such digital content may include audio clips, movie clips, TV clips, and music videos, as well as amateur content such as video blogging, short original videos, pictures, photos, etc.

One or more filters can be applied to the digital content to produce desired customized effects, such as a black and white effect, a high dynamic range (HDR) effect, a sepia effect, an enhancement effect, a brightness adjustment effect, an auto-focusing effect, etc. Filters can be automatically applied to content when the content is uploaded to a content hosting website, and/or a user can apply filters to the content prior to uploading the content.

### SUMMARY

In some implementations, a method to share videos with filters is presented. The method includes identifying first content, and determining a filter to be applied to the first content, wherein, when the filter is applied to the first content, filtered content is produced. The filter is then applied to the first content. A request is received to upload the filtered content, and, in response to the request, the first content and filter data are sent to a server. A resource identifier indicating the first content and the filter data is then received.

In some implementations, a request can be received from a user to view the filtered content, and the filtered content can be presented to the user. A request from the user to modify the filter can be received, and an indication of a modified filter can also be received, and modified filter data can be sent to the server.

The filter can be automatically selected or manually selected, and a setting for the filter can be received from the user. The filtered content can be presented to the user.

In some implementations, a request can be received to share the filtered content on a third party platform, and the resource identifier can be provided to the third party platform.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with one embodiment of the present disclosure.

FIG. 2 illustrates a content sharing system, in accordance with one embodiment of the present disclosure.

FIG. 3A is a flow diagram illustrating one embodiment for a server-side method of sharing content.

FIG. 3B is a flow diagram illustrating one embodiment for another server-side method of sharing content.

FIG. 4A is a flow diagram illustrating one embodiment for a client-side method of sharing content.

FIG. 4B is a flow diagram illustrating one embodiment for another client-side method of sharing content.

FIG. 5 is a block diagram of an exemplary computer system that may perform one or more of the operations described herein.

### DETAILED DESCRIPTION

Aspects of the disclosure pertain to a method of sharing filtered content, such as a filtered video or photograph, via a third party platform that enables a user to subsequently change the filters on the content and/or access the original raw video.

In some implementations, a method is provided that can be utilized in conjunction with a mobile recording application, which has the ability to apply filters to content before the content is uploaded to a third party platform, such as a social network, content hosting service or other application. After the content is captured by the user, a filter can be applied to the content (in response to a user request or automatically), and the user can select one or more third party platforms to upload the content for sharing with desired viewers. Previously, once the content was shared, the filters were a permanent aspect of the content and the original content was lost. However, according to an embodiment, the original content (e.g., the raw video) is preserved so that the filters can be changed and/or removed later.

According to an embodiment, the user can capture the content and a filter can be applied, either manually or automatically. The filtered version of the content can be displayed for the user, and when the user shares the content, instead of uploading the content directly to the third party platform, the content is instead hosted by a content server (e.g., a proxy service). Rather than uploading the filtered content, the original content is uploaded and the settings for the applied filters are also uploaded with the original content. The content server then stores the original content and the filter settings at a location identified by a resource identifier (e.g., a uniform resource locator (URL)), which is then shared to the third party platform. When the third party platform displays the content, the content server serves the filtered version of the content instead of the original content. In an example, the content server's filtered version can be encoded ahead of time and cached by the content server. However, in another example, the content server could apply the filter to the content in real-time as the content is served.

In another embodiment, rather than uploading only the original content and the filters, both the original and filtered versions of the content are uploaded (e.g., together), or a filtered version of the content and instructions on how to convert the filtered version to the original version could be uploaded.

In another embodiment, rather than uploading filter parameters, the differences (e.g., deltas) between the filtered content and the original content can be uploaded. These differences could be highly compressed in one example. Here, either the filtered or original version could be used as a base to which the deltas could be applied to obtain the other version.

In one embodiment, the method can be conducted whether the filter is applied while the content is being captured or subsequent to the capture of the content.

Examples of devices for uploading the content include, but are not limited to, mobile devices, dedicated video cameras, laptop computers, desktop computers, or tablets.

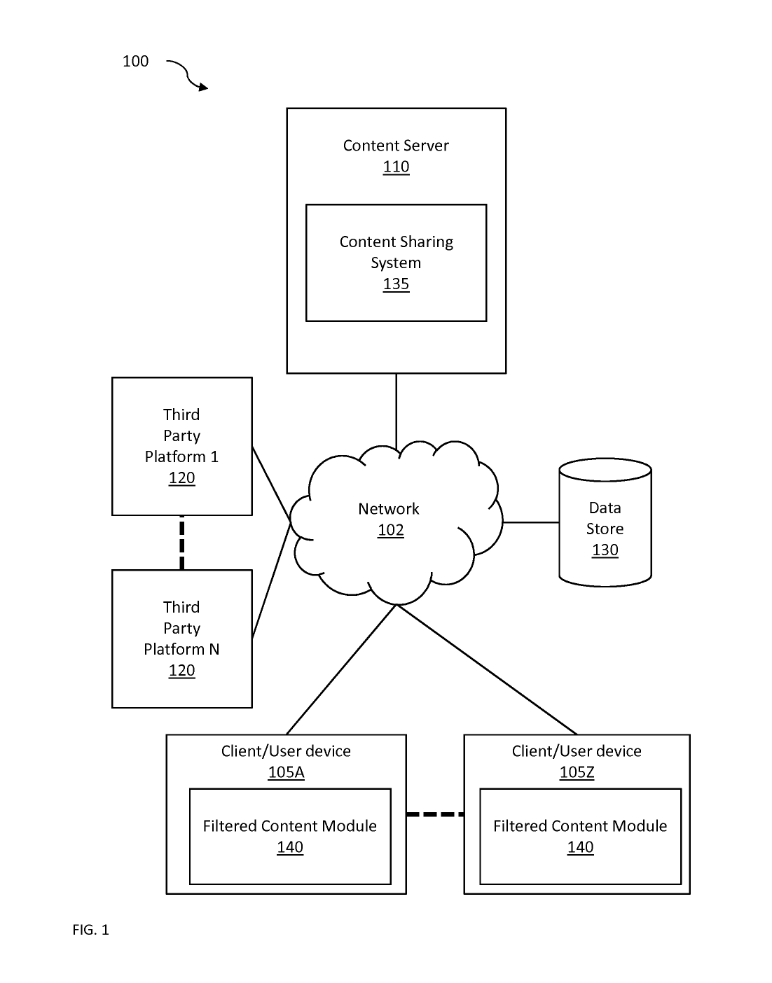

FIG. 1 illustrates exemplary system architecture 100, in accordance with one embodiment of the present disclosure. System 100 includes client/user devices 105A through 105Z in communication with (e.g., coupled to) a content server 110 and one or more third party platforms 120 over a network 102, and a data store 130. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The client/user devices 105A through 105Z may be any type of computing device, for example, a device including a processor, a computer-readable medium, and a memory. In some embodiments, the client/user device 105A through Z may be executing a browser application or other application adapted to communicate over Internet related protocols (e.g., TCP/IP and HTTP) and/or display a user interface. System 100 may support a large number of concurrent sessions with many client/user devices.

Each client/user device 105A through 105Z can include a media viewer. In one implementation, the media viewers may be applications that allow users to view content, such as images, videos, web pages, documents, etc. For example, the media viewer may be a web browser that can access, retrieve, present, and/or navigate content (e.g., web pages such as Hyper Text Markup Language (HTML) pages, digital media items, etc.) served by a web server. The media viewer may render, display, and/or present the content (e.g., a web page, a media viewer) to a user. The media viewer may also display an embedded media player (e.g., a Flash® player or an HTML5 player) that is embedded in a web page (e.g., a web page that may provide information about a product sold by an online merchant). In another example, the media viewer may be a standalone application that allows users to view digital media items (e.g., digital videos, digital images, electronic books, etc.). The media viewers may be provided to the client/user devices 105A through 105Z by the content server 110. For example, the media viewers may be embedded media players that are embedded in web pages provided by the content server 110. In another example, the media viewers may be applications that are downloaded from another server.

The content server 110 and the third party platforms 120 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

In one embodiment, the content server 110 provides content including media items (e.g., digital video, streaming video, images, digital music, streaming music, social media information, digital images, photographs, etc.) to one or more of the client/user devices 105. For example, the content server 110 may be part of a content sharing platform and may provide a media item, such as a streaming video, requested by a user for playback on the client/user device 105 via the network 102.

In one embodiment, the third party platforms 120 provide an Internet-based method of sharing content. For example, the third party platforms 120 can be a social network, an image sharing platform, a video sharing platform, etc. A user can share content with desired viewers via the third party platforms 120. For example, the third party platform 120 may be one or more computing devices (e.g., servers), data stores, networks, software components, and/or hardware components that may be used to allow users to connect to, share information, and/or interact with each other. The third party platform 120 can be, for example, a social network (SN) that may present to a user a listing (e.g., activity feed, feed, stream, wall, etc.) of objects (such as posts, content items (e.g., video, images, audio, etc.), status updates, favorability indications, tags, messages, and so on) generated by other users of the social network. The third party platform 120 may also include a content sharing aspect that allows users to upload, view, tag, and share content, such as text content, video content, image content, audio content, and so on. Other users of the third party platform 120 may comment on the shared content, discover new content, locate updates, share content, and otherwise interact with the provided content.

In one implementation, the third party platform 120 can be a mobile platform to allow users to connect to, share information, and/or interact with each other using one or more mobile devices, smart phones, tablet devices, and other mobile communication devices that allow users to communicate over a telecommunications network. For example, the mobile platform may enable telephony communication, Short Message Service (SMS) messaging, Multimedia Message Service (MMS) messaging, text chat, and video chat between users.

Data store 130 can include one or more writable persistent storage devices, such as memories, tapes or disks. Although each of content server 110, third party platforms 120, and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

During operation of system 100, a user captures content (i.e., original content), which may be captured via one of the client/user devices 105A through 105Z. In an embodiment, filtered content module 140 on the client/user device applies one or more filters (e.g., automatically or in response to a user request) to the original content to produce filtered content. Optionally, the filtered content is then displayed for the user. The user can then request that the filtered content be uploaded or shared via one or more of the third party platforms 1-N 120, and the filtered content module 140 uploads the original content and filter data (e.g., a filter, code for a filter, a filter identifier, and/or filter settings, if applicable) from the client/user device to the content server 110. The content server 110 receives the content and/or communications, and processes and/or directs the content and/or communications to content sharing system 135 accordingly. The content can be stored in the data store 130 such that the content can be accessed at a later time.

In an embodiment, the user can select one or more filters (and one or more filter settings, if applicable) to be applied to the original content, and these filter selections referred to herein as filter data can also be sent to the content sharing system 135 via one of the client/user devices 105A through 105Z and associated with the content in the data store 130. For example, if the user has captured video content, the user can select an HDR filter to apply to the video content. The user may also select an HDR setting (e.g., an HDR intensity) to apply to the video content. When the video content is uploaded to the content sharing system 135, an identifier of the HDR filter (and HDR filter setting) can be provided as well.

In an embodiment, filters (and filter settings, if applicable) can be applied automatically to the content. In other words, the filters can be applied to the content without being selected (or without a request) by the user. For example, if the user has captured video content, a stabilization filter can be automatically applied to the video content so that display of the filtered video content provides a more stable image and reduces the effect of movement of a camera capturing the video content.

In an embodiment, the user is able to view the filtered content (i.e., the original content with the associated filters (and filter settings) applied). Here, if the user is satisfied with the appearance of the filtered content, the user can indicate that the user would like to be able to share the filtered content with viewers.

The content sharing system 135 can provide the user with a resource identifier (e.g., a URL) that identifies the content, along with the filters, that is stored in the data store 130. The user can share (or post) the resource identifier via one or more of the third party platforms 120. In an example, the resource identifier includes meta data indicating a title of the content, a description of the content, and instructions for how the content should be rendered using the filters. In an embodiment, the third party platform 120 can serve the filtered content to viewers using the posted resource identifier. A viewer can select the resource identifier to view the filtered content, and the content server 110 can retrieve the original content and the filter data from the location specified by the URL, transform the original video using the filter data, and serve the filtered content to the viewer. For example, the viewer can select the resource identifier via the viewer's client/user device 105 and view the filtered content on the viewer's client/user device.

For example, a user can upload a video to the content server 110 via the filtered content module 140 along with an HDR filter identifier and an HDR filter setting. The content sharing system 135 can then automatically apply a stabilization filter to the video. The content sharing system 135 can store the video, the filters (or identifiers of the filters), and the filter setting in the data store 130, and associate the filters and filter setting with the video. The content sharing system 135 can then provide a resource identifier to the user for the user to share with desired viewers. The user can then share the resource identifier with the desired users through one or more the third party platforms 120. A viewer that desires to view the video can select the resource identifier via the third party platform 120. Upon selecting the resource identifier, the content server 110 serves the video with the HDR and stabilization filters applied, such that the filtered video is played back via the third party platform 120.

In an embodiment, the user can access the original content after the original content has been uploaded to the content server 110. The user could access the original content, or the user could modify the filters (and filter settings, if applicable) that are associated with the original content in the data store 130. For example, the user could select to undo the filter so that viewers, including the user, can view the original content, or the user could select to modify the filter (e.g., change filters or filter settings) so the viewers could view differently filtered content. In an embodiment, the user could use the previous resource locator to share the original content or differently filtered content. In another embodiment, the user would receive a new resource locator to use to share the original content or differently filtered content.

Further to the example above, the user can access the video that was uploaded to the content server 110, and be presented with the filtered video and the video settings identifying the applied filters. The user could request that the HDR and stabilization filters be removed, and then apply a different filter, e.g., a denoise filter, to the video. Here, the resource identifier previously posted by the user will still be linked to the content, however, the video available for viewing will be filtered with the modified filters.

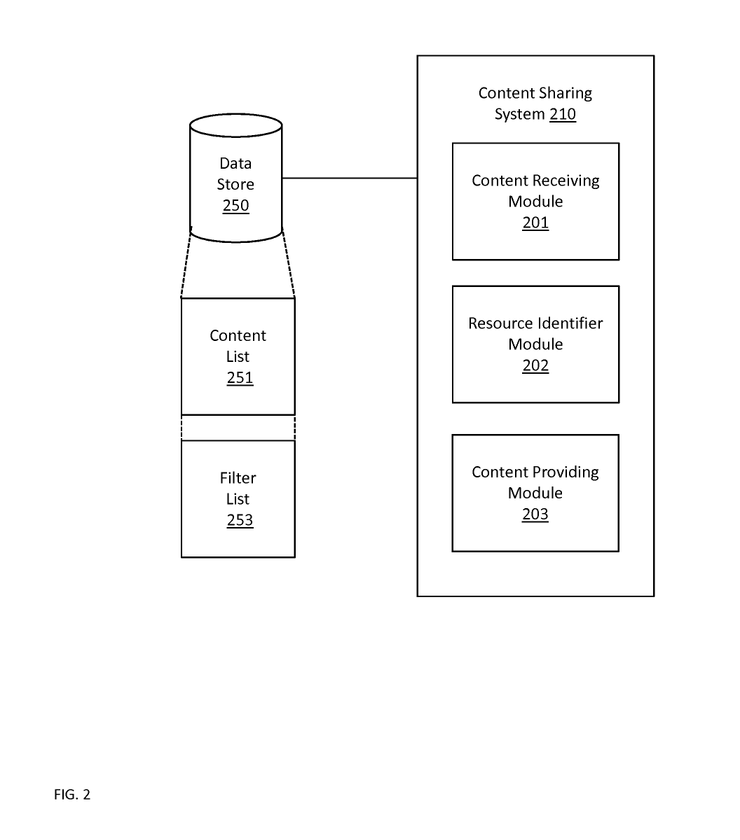

FIG. 2 illustrates a content sharing system 210, in accordance with one embodiment of the present disclosure. The content sharing system 210 may include a content receiving module 201, a resource identifier module 202, and a content providing module 203. More or less components may be included in the content sharing system 210 without loss of generality. In an embodiment, content sharing system 210 is content sharing system 135 and data store 250 is data store 130 shown in FIG. 1.

In an embodiment, the content receiving module 201 receives content (i.e., original content), such as a video or a digital image, from a user, which the content receiving module 201 stores in a content list 251 in data store 250. The content receiving module 201 can also receive one or more filters for the content, and can also receive settings for the filters, if applicable. When the filters (and settings) are applied to the content, filtered content is produced. The filters can be stored in filter list 253 in data store 250. The filters can be selected by the user or the filters can be automatically selected. For example, the filters can be automatically selected by the content sharing system 210.

In one embodiment, the filtered content is displayed for the user. The user can then approve the filtered content or the user can adjust the filters that are applied to the content.

The resource identifier module 202 can then generate a resource identifier that indicates the content along with the associated filters. For example, the resource locator can be a URL that indicates a location of the content and the associated filters. The resource identifier can also include meta data, which can include information about the content, the filters, and how the content should be served or displayed. The resource identifier can then be sent to the user. The user can then use the resource identifier to share the content. For example, the user can share the resource identifier on one or more third party platforms.

A viewer can request to view the content via the third party platform by selecting the resource identifier. For example, the viewer can select the URL by clicking on the URL. The request to view the content can be received by the content sharing system 210 (e.g., via a third party platform). Upon receiving the request to view the content, the content providing module 203 can serve the content for presentation to the viewer. For example, content providing module 203 can provide the content with the associated filters applied such that the viewer can view the filtered content.

In an embodiment, the content providing module 203 can also provide the original content to the viewer.

In an embodiment, the user can access the original content from the content list 251 at a later time. The user may desire to remove all of the associated filters, apply different filters, or change settings of the associated filters.

In another embodiment, the content receiving module 201 receives the original content along with differences between the original content and filtered content. The differences can be stored in the data store and associated with a resource identifier by the resource identifier module 202. The user can then share the resource identifier via one or more third party platforms. When the viewer requests to view the content, the content providing module 203 can provide the filtered content by applying the differences to the original content. However, the user is still able to access the original content stored in the content list 251. As a result, the user can choose to share the original content with desired viewers, or modify the filters associated with the original content such that new differences between the original content and filtered content can be uploaded to the content sharing system 210.

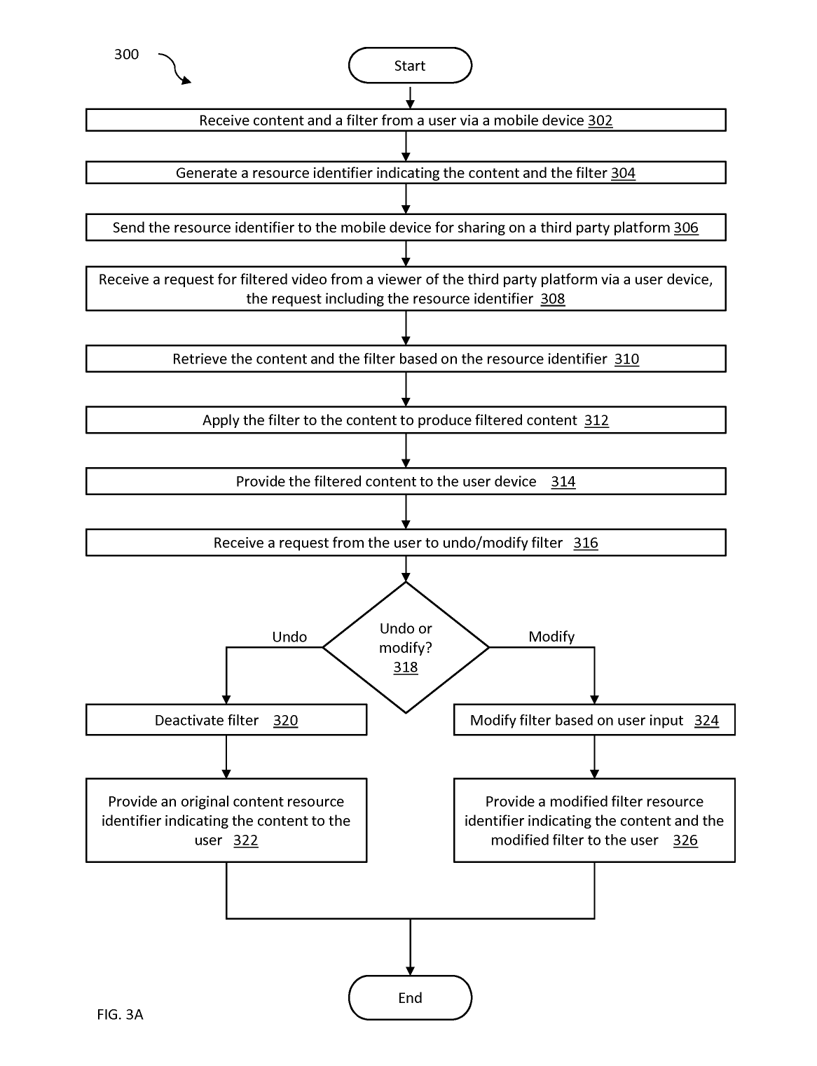

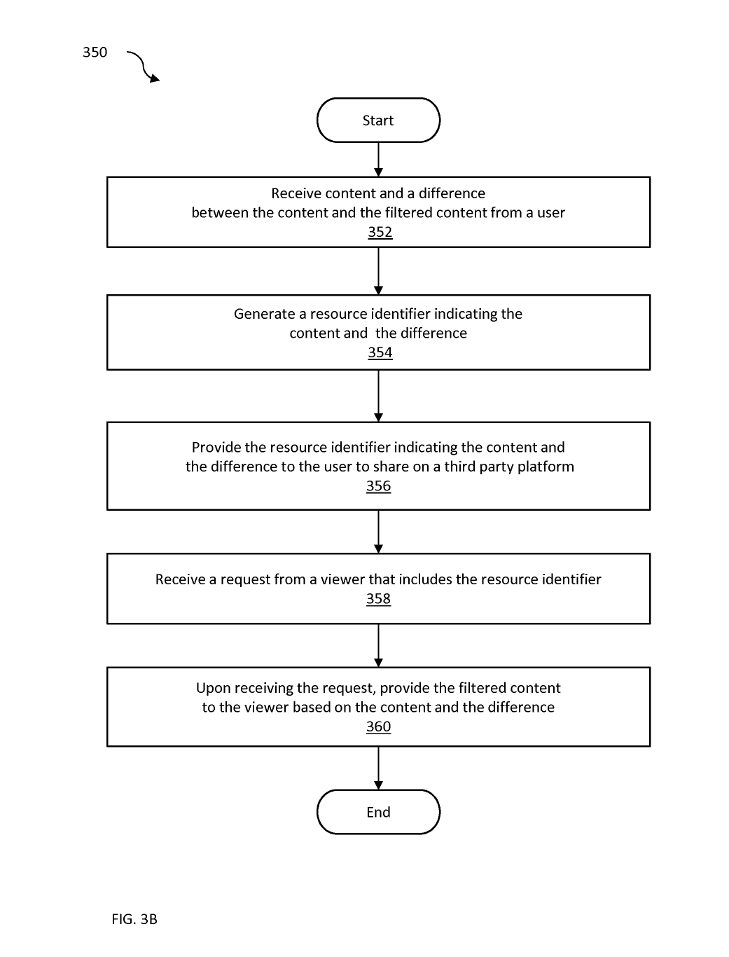

FIG. 3A is a flow diagram illustrating an embodiment for a server-side method 300 of sharing content. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the content server 110 of FIG. 1).

At block 302, processing logic receives original content and one or more filters from a user, e.g., via a mobile device. For example, the user can upload original content, such as video or digital images.

In one embodiment, one or more filters are determined automatically. For example, a denoise filter could be automatically applied to a video. In another example, the content could be automatically analyzed to determine which filters should be applied, such as a stabilizing filter for a video that is determined to be shaky or an enhance filter for a video that is determined to be too dark or to not have enough contrast.

In another embodiment, one or more filters can be determined based on user selection. For example, the user could select certain filters to obtain certain effects for the content. In an example, the user could select a sepia filter to obtain an aged effect on a video.

At block 304, processing logic generates a resource identifier identifying the original content and filters, e.g., in response to a user request to share the filtered content via one or more third party platforms. The resource identifier can include metadata that indicates information about the content including how the content should be displayed.

At block 306, processing logic sends the resource identifier indicating the original content and the filters to the user to share on one or more third party platforms. The user can then share the resource identifier on the third party platform such that desired viewers are able to access the resource identifier to be able to view the content.

At block 308, processing logic receives a request for filtered video from a viewer of the third party platform via a user device that indicates the resource identifier. Here, the viewer has selected to view the content. For example, the viewer can click on or select, via the third party platform, a URL that serves as the resource identifier, and the third party platform can the selected URL to the content server.

At block 310, processing logic retrieves the original content and the filter based on the resource identifier. At block 312, processing logic applies the filter to the original content to produce filtered content. At block 314, processing logic provides the filtered content to the viewer via the user device. For example, the filtered content is displayed for the user to view. In an embodiment, the viewer can also access the original content. At block 316, processing logic receives a request from the user to undo or modify the filter. If, at block 318, processing logic determines that the request is to undo one or more filters, at block 320, in response to the request, processing logic deactivates the filter, and at block 322, provides an original content resource identifier indicating original content to the user, where the original content resource identifier may be the same as the previous resource identifier or may be different from the previous resource identifier.

If, at block 320, processing logic determines that the request is to modify one or more filters, at block 324, processing logic modifies one or more filters based on user input, and, at block 326, provides a modified filter resource identifier indicating original content and the modified filter to the user, where the modified filter resource identifier can be the same as or different from the previous resource identifier.

FIG. 3B is a flow diagram illustrating an embodiment for a server-side method 350 of sharing videos. The method 350 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 350 is performed by a server (e.g., the content server 110 of FIG. 1).

At block 352, processing logic receives original content and differences between the original content and filtered content from a user. For example, the user can select one or more filters to apply to the original content to produce filtered content, and then a difference between the filtered content and the original content can be determined.

At block 354, processing logic generates a resource identifier indicating the original content and the difference. For example, the resource identifier can be a URL.

At block 356, processing logic sends the resource identifier indicating the original content and the difference to the user to share on a third party platform.

At block 358, processing logic receives a request from a viewer that indicates the resource identifier. Here, the viewer has selected to view the content. For example, the viewer can click on or select a URL that serves as the resource identifier.

At block 360, processing logic, upon receiving the request, provides the filtered content to the viewer. For example, the filtered content is displayed for the viewer to view.

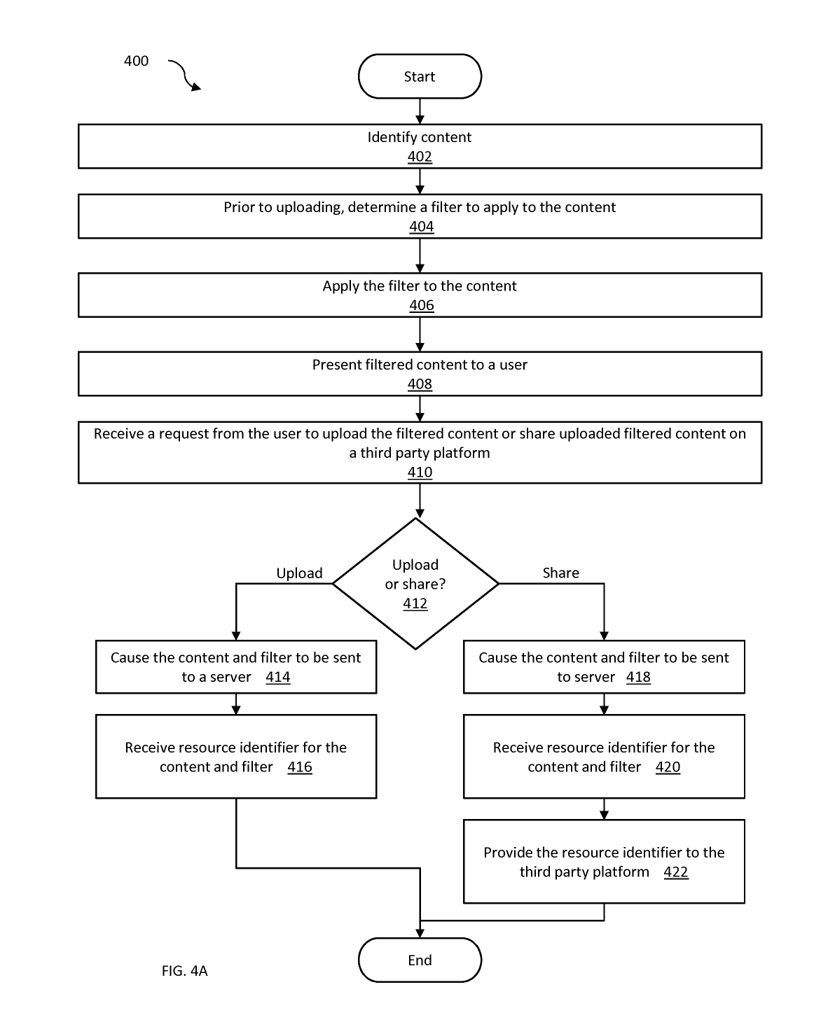

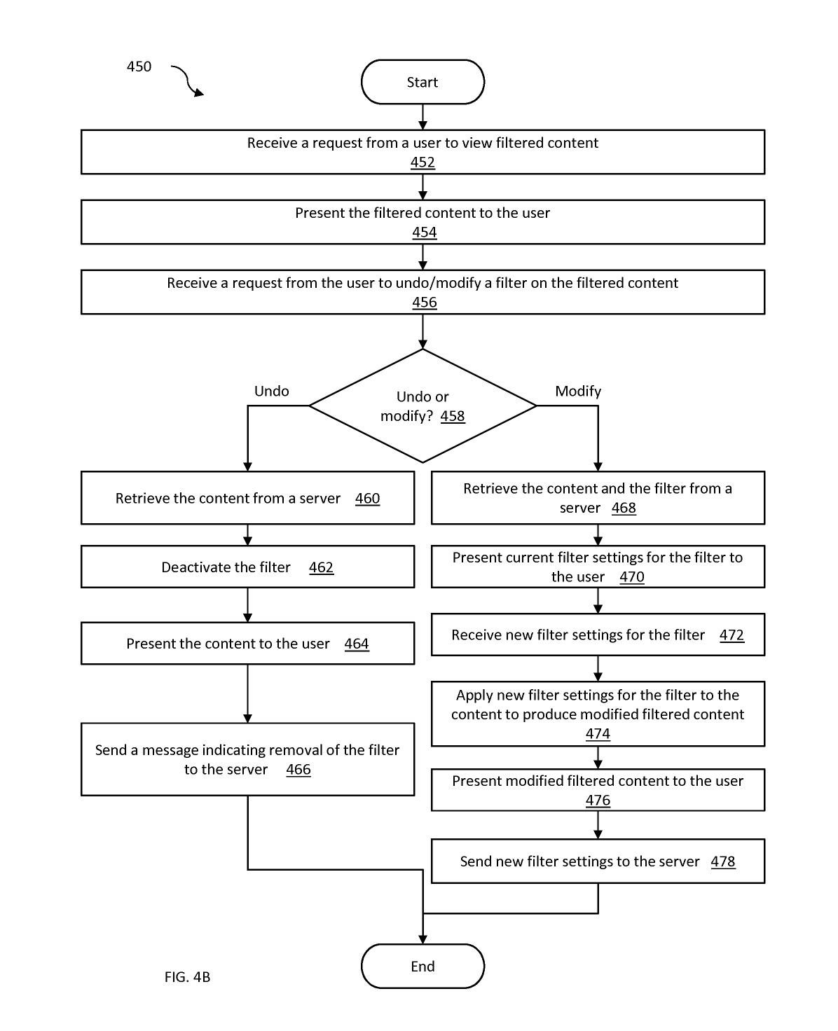

FIG. 4A is a flow diagram illustrating an embodiment for a client-side method 400 of sharing videos. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by a client/user device (e.g., the filtered content module 140 of the client/user devices 105A-105Z of FIG. 1).

At block 400, processing logic identifies original content, e.g., either recorded by a client/user device or received by the client user device. At block 404, processing logic, prior to uploading the original content, determines a filter to apply to the original content, e.g., automatically or from user input. At block 406, processing logic applies the filter to the original content to produce filtered content. Optionally, at block 408, processing logic presents filtered content, presents the filtered content to a user.

At block 410, processing logic receives a request from the user to upload the filtered content or share uploaded filtered content on a third party platform. If, at block 412, processing logic determines that the request was to upload the filtered content, then, at block 414, processing logic causes the original content and filter to be sent to a server, and, at block 416, receives a resource identifier for the original content and filter.

If, at block 412, processing logic determines that the request was to share uploaded filtered content, then, at block 418, processing logic causes the original content and filters to be sent to the server, at block 420, receives a resource identifier for the original content and the filters, and at block 422, provides the resource identifier to the third party platform.

FIG. 4B is a flow diagram illustrating an embodiment for a client-side method 450 of sharing videos. The method 450 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 450 is performed by a client/user device (e.g., the filtered content module 140 of the client/user devices 105A-105Z of FIG. 1).

At block 452, processing logic receives a request from a user to view filtered content, and at block 454, processing logic presents the filtered content to the user. At block 456, processing logic receives a request from the user to undo or modify one or more filters on the filtered content. If, at block 458, processing logic determines that the request was to undo one or more filters, then, at block 460, processing logic retrieves original content from a server, at block 462, deactivates one or more filters, at block 464, presents original content to the user, and, at block 466, sends a message indicating removal of the filter to the server.

If, at block 456, processing logic determines that the request was to modify one or more filters, then, at block 468, processing logic retrieves original content and the filters from a server, and, at block 470, presents current filter settings for the filter to the user. At block 472, processing logic receives new filter settings for the filters, at block 474, applies the new filter settings for the filter to the original content to produce modified filtered content, at block 476, presents the modified filtered content to the user, and at block 478, sends the new filter settings to the server.

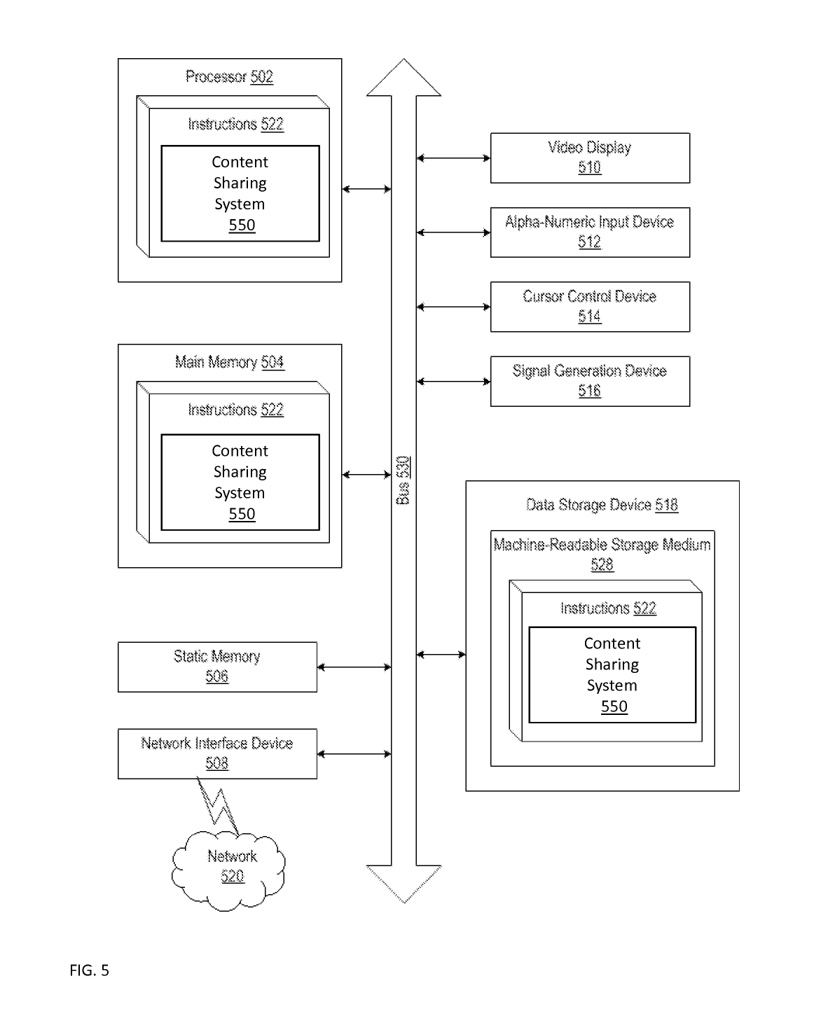

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a computer-readable storage medium 528 (or machine-readable storage medium) on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 522 may further be transmitted or received over a network 520 via the network interface device 508.

In one embodiment, the instructions 526 include instructions for a content sharing system 550, which may correspond to content sharing system 135 of FIG. 1, and/or a system for sharing filtered content. While the computer-readable storage medium 528 (or machine-readable storage medium) is shown in an exemplary embodiment to be a single medium, the term “computer-readable storage medium” (or “machine-readable storage medium”) should be taken to include a single medium or multiple media (e.g., a centralized or distributed database, and/or associated caches and servers) that store the one or more sets of instructions. The term “computer-readable storage medium” (or “machine-readable storage medium”) shall also be taken to include any medium that is capable of storing, encoding or carrying a set of instructions for execution by the machine and that cause the machine to perform any one or more of the methodologies of the present disclosure. The term “computer-readable storage medium” (or “machine-readable storage medium”) shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

We claim:

1. A method, implemented by a user device, comprising:
identifying, via the user device, first content;
determining, via the user device, a filter to be applied to the first content, wherein, when the filter is applied to the first content, filtered content is produced;
applying, by the user device, the filter to the first content;
receiving, by the user device, a request to upload the filtered content;
in response to the request to upload the filtered content, causing, by the user device, the first content and filter data to be sent to a server; and
in response to causing the first content and the filter data to be sent to the server, receiving a resource identifier indicating the first content and the filter data.

2. The method of claim 1 further comprising:
receiving a request from a user to view the filtered content;
presenting the filtered content to the user;
receiving a request from the user to modify the filter;
receiving an indication of a modified filter; and
sending modified filter data to the server.

3. The method of claim 1, wherein determining the filter comprises automatically selecting the filter.

4. The method of claim 1 further comprising: receiving a request to share the filtered content on a third party platform; and
providing the resource identifier to the third party platform.

5. The method of claim 1 wherein the filter data comprises an identifier of the filter and a setting for the filter.

6. The method of claim 1 further comprising:
receiving a request from the user to undo the filter; and
sending a message indicating a filter deactivation for the first content at the server.

7. The method of claim 1, wherein determining the filter comprises receiving an indication of the filter from a user.

8. The method of claim 1, wherein the filter data comprises code for the filter.

9. The method of claim 1, wherein the filter data comprises an identifier of the filter.

10. A non-transitory computer readable storage medium having instructions that, when executed by a processing device, cause the processing device to perform operations comprising:
receiving first content and filter data from a user via a mobile device;
generating a resource identifier indicating the first content and the filter data;
sending the resource identifier to the mobile device to share on a third party platform;
receiving a request from the user to modify the filter, the request comprising modified filter data;
in response to the request from the user, modifying the filter based on the modified filter data; and
providing a modified filter resource identifier indicating the first content and the modified filter data to the mobile device to share on the third party platform.

11. The non-transitory computer readable storage medium of claim 10, wherein modifying the filter comprises deactivating the filter.

12. The non-transitory computer readable storage medium of claim 10, further comprising providing the filtered content to the user via the mobile device.

13. The non-transitory computer readable storage medium of claim 10, wherein the filter is automatically selected.

14. The non-transitory computer readable storage medium of claim 10, wherein the operations further comprise receiving a setting for the filter from the user.

15. The non-transitory computer readable storage medium of claim 10, wherein the operations further comprise receiving differences between the first content and the filtered content from the user.

16. The non-transitory computer readable storage medium of claim 10, wherein the operations further comprise receiving a request for filtered content from a viewer of the third party platform via a viewer device, the request comprising the resource identifier;
upon receiving the request from the viewer, retrieving the first content and the filter data based on the resource identifier;
applying the filter data to the first content to produce the filtered content;
providing the filtered content to the viewer device.

17. A computing device comprising:
a memory; and
a processing device coupled to the memory, wherein the processing device is to:
identify first content;
determine a filter to be applied to the first content, wherein, when the filter is applied to the first content, filtered content is produced;
apply the filter to the first content;
receive a request to upload the filtered content;
in response to the request to upload the filtered content, cause the first content and filter data to be sent to a server; and
in response to causing the first content and the filter data to be sent to the server, receive a resource identifier indicating the first content and the filter data.

18. The computing device of claim 17, wherein the processing device is further to:
receive a request from a user to view the filtered content;
present the filtered content to the user;
receive a request from the user to modify the filter;
receive an indication of a modified filter; and
send modified filter data to the server.

19. The computing device of claim 17, wherein, to determine the filter, the processing device is to automatically select the filter.

20. The computing device of claim 17, wherein the processing device is further to:
receive a request to share the filtered content on a third party platform; and
provide the resource identifier to the third party platform.

21. The computing device of claim 17, wherein the filter data comprises an identifier of the filter and a setting for the filter.

22. The computing device of claim 17, wherein the processing device is further to:
receive a request from the user to undo the filter; and
send a message indicating a filter deactivation for the first content at the server.
